(19) United States
(12) Patent Application Publication
(10) Pub. No.: US 2014/0112601 A1
(43) Pub. Date: Apr. 24, 2014

(54) ZIPPER TAPE AND BAG BODY COMPRISING ZIPPER TAPE

(71) Applicants: Hiroko Shioda, Sodegaura-shi (JP); Michio Mogami, Sodegaura-shi (JP)

(72) Inventors: Hiroko Shioda, Sodegaura-shi (JP); Michio Mogami, Sodegaura-shi (JP)

(73) Assignee: IDEMITSU UNITECH CO., LTD., Minato-ku, Tokyo (JP)

(21) Appl. No.: 14/114,246

(22) PCT Filed: Mar. 27, 2012
(86) PCT No.: PCT/JP2012/002115

§ 371 Date: Jan. 10, 2014

(30) Foreign Application Priority Data
Apr. 27, 2011 (JP) 2011-098984
Jul. 8, 2011 (JP) 2011-151499

(51) Int. Cl. B65D 33/24; A61G 17/06

(52) U.S. Cl. CPC B65D 33/24; A61G 17/06
USPC 383/64; 24/400

(57) ABSTRACT

A bag body provided with a zipper tape in which both openability by hands and openability by an automatic machine are improved while ensuring the opening strength on the contents side in order to prevent the leakage of the contents is provided. A zipper tape is configured such that the distance A between a front end part of a female part on the non-opening side and a top part on a protruded part on the opening side, the distance B between a front end part of a female part on the non-opening side and a front part opposing to a stripe-shaped base in a protruded part on the non-opening side, and the angle C formed by a protruded part on the non-opening side and a side surface of a shaft part connecting therewith satisfies the relationship represented by the following formula: A−B≦0.20 mm and 50°≦C≦85°.

### TECHNICAL FIELD

The present invention relates to a zipper tape and a bag body provided with a zipper tape. In particular, the present invention relates to a zipper tape and a bag body provided with a zipper tape which can be applied to an automatic filling and packaging machine designed for automatic opening and closing of a zipper and filling of contents.

### BACKGROUND ART

Conventionally, a bag body provided with a zipper tape which, although being freely openable and closable, can seal an opening has been used in various fields such as foods and pharmaceuticals.

It is needless to say that, such a bag body provided with a zipper tape is required to have an opening strength on the contents side which is sufficient enough to prevent leakage of the contents, and also is required to be excellent in openability for realizing easy opening.

In response to such requirements, for example, in Patent Documents 1 and 2, a bag body provided with a zipper tape in which improvement in openability has been sought is proposed.

### RELATED ART DOCUMENTS

Patent Document 1: JP-A-H09-118343

Patent Document 2: JP-A-2002-360313

### SUMMARY OF THE INVENTION

### Subject to be Solved by the Invention

However, in conventional bag bodies provided with a zipper tape, although improvement in openability by hands was intended, no attention was paid to improvement in openability by a machine

In general, a bag body is filled with contents by an automatic filling and packaging machine (FFS, for example, hereinafter referred to as an automatic machine or a machine). Such an automatic machine conducts opening of a bag body, filling of contents and sealing of a bag body automatically. A bag body provided with a zipper tape is loaded in such an automatic machine to be produced as a bag.

In the opening step by means of an automatic machine, for example, as shown in FIG. 5(a), a sucker 200 is disposed so as to sandwich the vicinity of an opening part 110 from the outside of a bag body 110, and the opening part 110 is sucked by this sucker 200 in a direction perpendicular (horizontal, in the figure) to the bag body 100, whereby the opening part is opened.

On the other hand, as shown in FIG. 5(b), in the case of opening by hands, the bag body 100 can be opened by holding end parts 111 of the bag body 100 and pulling them right and left (horizontal, in the figure).

At this time, an external force is gradually transmitted from the end part 111 of the bag body 100 to the contents side. Therefore, unlike the vertical (horizontal, in the figure) force applied as in the case of opening by means of an automatic machine, an external force (f) directed obliquely downward acts on a zipper tape 1.

That is, although opening by hands and opening by means of a machine differ in direction of a force applied to the zipper tape 1, openability by hands is regarded as important, and sufficient consideration was not made on openability by means of a machine.

Therefore, in the step of opening by means of an automatic machine, there was a problem that insufficient opening that the opening part is not opened reliably occurred, leading to lowering of production efficiency.

The present invention has been made in view of the above-mentioned circumstances. By specifying an optimum shape of an occlusion part which occludes the opening part by engagement based on prescribed evaluation items which are established taking opening by hands and opening by a machine into consideration, a zipper tape and a bag body provided with a zipper tape which have excellent openability not only by hands but also by a machine while ensuring the opening strength on the contents side are provided.

### Means for Solving the Subject

In order to attain the above-mentioned object, the zipper tape of the present invention is a zipper tape comprising a strip-shaped base provided along the inner circumference of an opening of a bag body for accommodating a prescribed contents; and a male part and a female part which are provided in the strip-shaped base in a protruded manner and can be engaged with each other,
the male part comprises:
   a head part that forms a protruded part on the opening side which protrudes from the opening to the outside of the bag body and a protruded part on the non-opening side which protrudes from the opening to the contents side; and a shaft part which connects the head part and the strip-shaped base;
the female part comprises:
   a female part on the opening side and a female part on the non-opening side, each female part having an end part in the form of a hook such that it opposes to the strip-shaped base,
   the female part on the opening side is engaged with the protruded part on the opening side and the female part on the non-opening side is engaged with the protruded part on the non-opening side;
   wherein in an engagement state in which one of the male part and the female part abuts the stripe-shaped base of the other,
   the distance A between the front end part of the female part on the opening side and the top part of the protruded part on the opening side, the distance B between the front end part of the female part on the non-opening side and the front part opposing to the stripe-shaped base in the protruded part on the non-opening side, and the angle C formed by the protruded part on the non-opening side and the side surface of the shaft part connecting therewith satisfies the relationship represented by the following formulas:

A−B≦0.20 mm

C=50°≦85°

The bag body provided with a zipper tape according to the present invention is a bag body for accommodating prescribed contents and is provided with the above-mentioned zipper tape.

### Advantageous Effects of the Invention

According to the present invention, by specifying an optimum dimension and an optimum shape of an occlusion part which occludes by engagement, it is possible to improve both openability by hands and openability by a machine while ensuring the opening strength on the contents side, whereby insufficient opening can be eliminated, and as a result, production efficiency can be improved.

### BRIEF DESCRIPTION OF THE DRAWINGS

FIG. 1 is a cross-sectional view of a zipper tape according to one embodiment of the present invention; in which (a) is a view showing the engagement is released; and (b) is a view showing the engagement state;

FIG. 2 is a table showing the results of evaluating the zipper tapes of one embodiment of the present invention which differ in dimension and shape according to a plurality of evaluation items;

FIG. 3 is a view showing the results of evaluating a region of the zipper tape according to one embodiment of the present invention having an optimum dimension and shape of the occlusion part in comparison with other regions;

FIG. 4 is a view showing a bag body provided with a zipper tape according to one embodiment of the present invention, in which (a) is a front view and (b) is a cross-sectional view taken along the line a-a in the opened state;

FIG. 5 is a schematic cross-sectional view showing the manner in which the bag body provided with a zipper tape according to one embodiment of the present invention is opened, in which (a) is a view showing the opening by means of a sucker and (b) is a view showing the opening by hands;

FIG. 6 is a schematic cross-sectional view showing the opening process of the bag body provided with a zipper tape according to one embodiment of the present invention, in which (a) is a view showing the state immediately before the engagement on the opening side is released; and (b) is a view showing the state after the engagement on the opening side is released and immediately before the engagement on the non-opening side is released;

FIG. 7 is a cross-sectional view showing the opening process of the bag body provided with a zipper tape according to Comparative Example, in which (a) is a view showing the state immediately before the engagement on the opening side is released; and (b) is a view showing the state after the engagement on the opening side is released and immediately before the engagement on the non-opening side is released; and

FIG. 8 is a cross-sectional view of the bag body provided with a zipper tape according to another embodiment of the present invention, in which (a) is a view showing a zipper tape having a plurality of pairs of a male part and a female part; and (b) is a view showing a zipper tape in which the end part on the contents side in the female-side tape is not fused.

### MODE FOR CARRYING OUT THE INVENTION

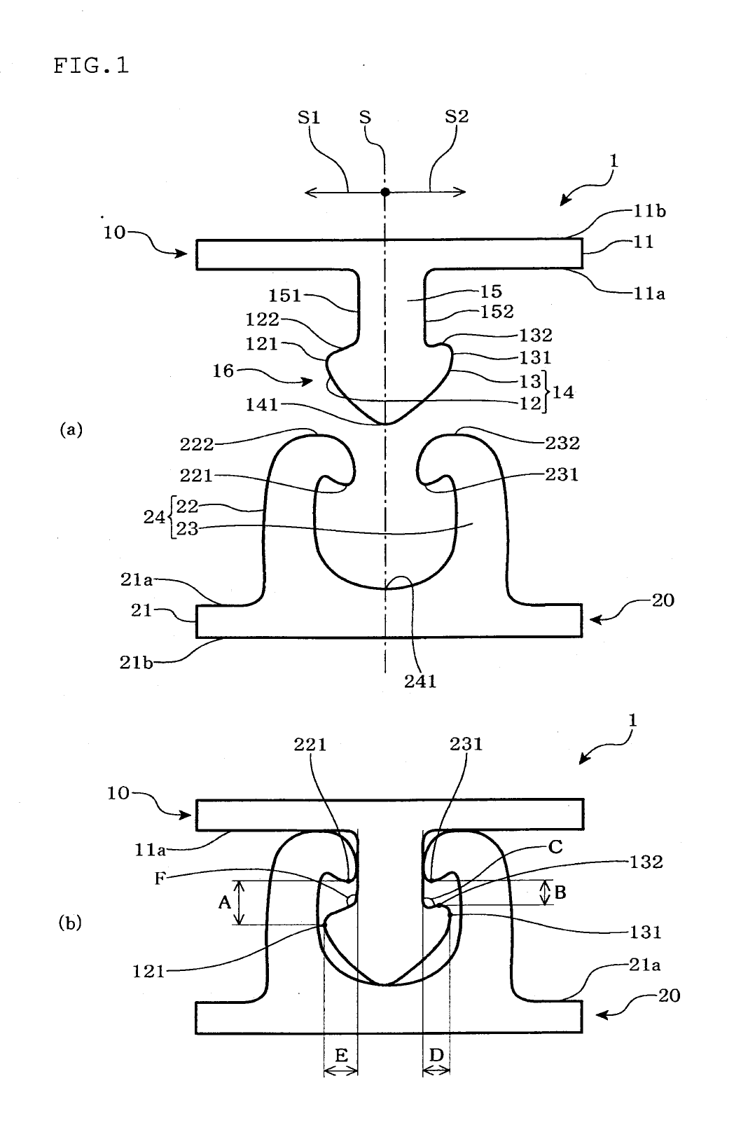

Hereinbelow, as for the zipper tape 1 and the bag body 100 provided with the zipper tape 1, an explanation will be made with reference to FIGS. 1 to 8.

### [Zipper Tape]

The zipper tape 1 according to the embodiment of the present invention is a zipper tape, which, as shown in FIGS. 1 to 6, is attached along the inner circumference of the opening part 110 of the bag body 100 having a bag shape capable of accommodating prescribed contents.

The zipper tape 1 is attached to an opening part 110 by fusing to sheets 101 and 101′ constituting the bag body 100 by thermal press or the like. By pushing (sandwiching) the vicinity of the zipper tape 1 from outside the bag body 1, the male part and the female part are engaged, whereby the opening part 110 can be sealed. Also, by applying an external force that pulls the end parts 111 of the bag body 100 apart, the engagement is released, thereby enabling the opening part 110 to be opened.

Further, the zipper tape 1 is configured such that, in the opening of the opening part 110, by applying an appropriate external force in the opening by a machine, as in the case of the opening by hands, favorable openability can be realized while ensuring the opening strength on the contents side to prevent leakage of contents.

Hereinbelow, each part constituting the zipper tape 1 will be explained.

As shown in FIG. 1(a), the zipper tape 1 is formed of a male-side tape 10 and a female-side tape 20. They respectively have a stripe-shaped base 11 and a stripe-shape 21 which are attached along the inner circumference of the opening part 110.

In each of the stripe-shaped bases 11 and 21, its backside 11b and 21b are fused such that they oppose to the inner circumference. On the surfaces 11a and 21a, a male part 16 and a female part 24 which are formed as an occlusion part and are engaged with each other are respectively formed.

The male part 16 is formed of a head part 14 having an approximately heart-shaped cross-sectional shape and a shaft part 15 connecting the head part 14 with the stripe-shaped base 11.

In the head part 14, protruded parts 14 which extend to the both sides than the shaft part 15 are formed. Due to the engagement of the protruded parts 14 respectively with the female parts 22 and 23, occlusion by engagement is realized.

Here, since the head part 14 of this embodiment is formed asymmetrically with respect the center line S. Therefore, with the center line S being as the border, the direction from the opening part 110 to the outside the bag body is taken as the opening side S1 and the direction from the opening part 110 to the inside of the bag (in which the contents is filled) is taken as the non-opening side S2.

The protruded part 14 has a protruded part 12 on the opening side and a protruded part 13 on the non-opening side. Although they are connected at a top part 141 of the head part 14, they are formed asymmetrically.

In the protruded part 12 on the opening side, a top part 121 which is most extended to the opening side S1 and an inclined surface 122 of the protruded part 12 on the opening side which connects this top part 121 and a side surface 151 of the shaft part are formed.

In the protruded part 13 on the non-opening side, a top part 131 which is most extended to the non-opening side S2 and a front part 132 which opposes to the stripe-shaped base 11 (11a) are formed. This front part 132 is a part which is closest to the stripe-shaped base 11 in the protruded part 13 on the non-opening side.

Female parts 24 (22, 23) are independently formed on a stripe-shaped base 21 (21a) in a protruded manner, and they are formed in a line-symmetrical manner relative to the center line S.

The female parts 22 and 23 are formed in a curved manner to have a hook-like shape such that their end parts 221 and 231 oppose to the stripe-shaped base 21.

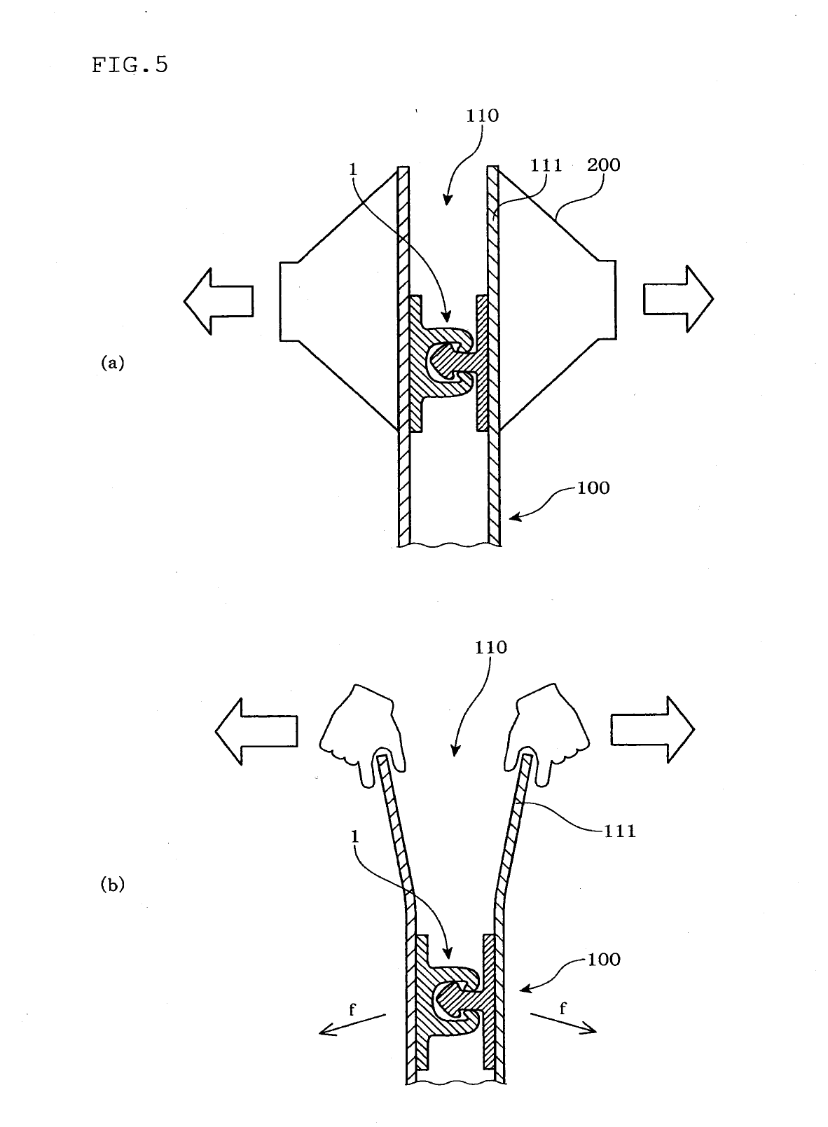

Due to such curved formation, as shown in FIG. 1(b), by pushing of the male part 16 between the female part 22 and the female part 23, the female part 22 and the protruded part 12 on the opening side are engaged, and the female part 23 and the protruded part 13 on the non-opening side are engaged, occlusion by engagement is attained, whereby the opening part 110 is sealed (see FIG. 5).

As mentioned below, the shape of the above-mentioned part is specified by dimension.

As for the specification by dimension, the specification is conducted in the engagement state where one of the male part 16 and the female part 24 abuts the stripe-shaped base of the other, i.e. the state where the top part 141 of the head part 14 almost abuts a bottom part 241 of the female part 24 and the respective top parts 222 and 232 of the female parts 22 and 23 almost abut the strip-shaped base 11 (11a).

Specifically, as shown in FIG. 1(b), as for the shape of each part, specification is made such that the distance A between the front end part 221 of the female part 22 on the opening side and the top part 121 of the protruded part 12 on the opening side, the distance B between the front end part 231 of the female part 23 on the non-opening side and the front part 132 opposing to the stripe-shaped base 11 in the protruded part 13 on the non-opening side, and the angle C formed by the protruded part 13 on the non-opening side and the side surface 152 of the shaft part connecting therewith satisfies the relationship represented by the following formula:

A−B≦0.20 mm (provided that 0≦A) (1)

C=50°≦85° (2)

In this embodiment, since the female parts 22 and 23 are respectively formed symmetrically, although varies differ, the distance A is equivalent to the distance between the stripe-shaped based 11 (11a) and the top part 121 of the protruded part 12 on the opening side, and the distance B is equivalent to the distance between the stripe-shaped base 11 (11a) and the top part 132 of the protruded part 13 on the non-opening part, these formulas definitely specify the shape of the male part 16.

In addition, although the formula 1 specifies the upper limit dimension (0.20 mm), it does not specify the lower limit dimension. Therefore, this formula is taken into consideration not only a shape in which the distance A is longer than the distance B, but also a shape in which the distance B is longer than the distance A.

In addition, as for the male part 16, the distance D between the side surface 152 of the shaft part and the top part 131 of the protruded part 13 on the non-opening side, the distance E between the side surface 151 of the shaft part and the top part 121 of the protruded part 12 on the opening side, and the angle F formed by the protruded part 12 on the opening side and the side surface 151 connecting therewith have the dimensions satisfying the following formula:

0.12 mm≦D≦0.22 mm (preferably 0.15 mm≦D≦0.20 mm) (3)

0.12 mm≦E≦ to 0.20 mm (preferably 0.13 mm≦E≦0.18 mm) (4)

100°≦F≦140° (preferably 115°≦F≦135°) (5)

These values are specified for the following reasons. As for the distance D and the distance E, as these distances are reduced, openability is improved. As for the angle F, as this angle becomes obtuse, openability is improved. However, the opening strength on the contents side is lowered. Therefore, the above-mentioned dimensions are specified such that both openability and the opening strength on the contents side are improved.

The shape of each part specified by the dimensions is determined by the following evaluation.

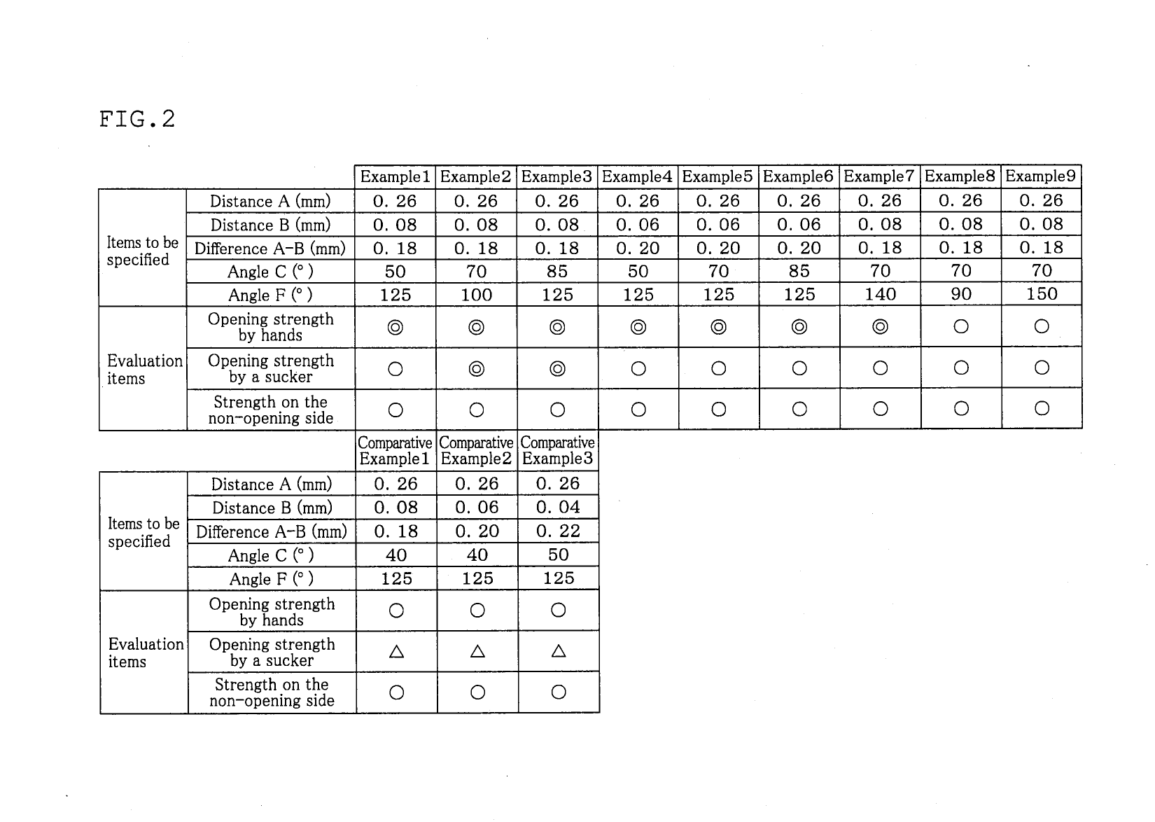

FIG. 2 is a table showing the results of evaluating zipper tapes of Examples 1 to 9 and Comparative Examples 1 to 3 in accordance with a plurality of items to be specified, in which any one or more of the distance A, the distance B, the angle C and the angle F (serving as the items to be specified) are different from each other.

The items to be specified are the “opening strength by hands” which is the standard taking into consideration opening by hands, the “opening strength by a sucker” which is the standard taking into consideration opening by a machine, and the “strength on the non-opening side” which shows the strength when the bag is opened with the contents side being held.

The symbols (⊚∘Δx) are independently show the results of evaluation. The male part 16 and the female part 24 are pulled apart with a prescribed pulling speed (300 mm/min, for example) and the maximum tensile strength when the engagement is released is measured by means of a prescribed measurement instrument (DPZ-200N, a digital force gauge manufactured by IMADA Co., Ltd., for example), and the measured value is distinguished by these symbols in accordance with the prescribed evaluation standard.

The “opening strength by hands” indicates the results of a tensile test in which the male part 16 and the female part 24 are pulled apart while the end part on the opening side of the zipper tape 1 (single body) which is in the engagement state being held.

In this test, since the zipper tape is pulled while the end part on the opening side thereof is being sandwiched, the male part 16 and the female part 24 are gradually pulled apart from the opening side S1 to the non-opening side S2. Therefore, this test closely resembles opening by hands.

In this test, a zipper tape having the maximum tensile strength of 10 or more and less than 25 (unit: N/50 mm, the same applies hereinbelow) is evaluated as “⊚”, a tensile strength of 5 or more and less than 10 or 25 or more and less than 30 is evaluated as “∘”, and a tensile strength of less than 5 or 30 or more is evaluated as “Δ”. These evaluations are made by setting a high value on openability by hands.

Regarding the “opening strength by a sucker”, as shown in FIG. 5(a), a tensile test is conducted in which the zipper tape 1 which is in the engagement state 1 is located on the one-third below the entire sucker (200), and while vacuum sucking the bag body 100 (65 MPa, for example), the male part 16 and the female part 24 are pulled apart from each other.

Since the vicinity of the zipper tape 1 is pulled in a direction perpendicular to the bag body 100, this test closely resembles opening by a machine.

Further, in this test, a maximum tensile strength of 5 or more and less than 12 is evaluated as “⊚”, a maximum tensile strength of 12 or more and less than 15 is evaluated as “∘”, and a maximum tensile strength of 15 or more is evaluated as “Δ”.

The “strength on the non-opening side” shows the results of a tensile strength in which the male part 16 and the female part 24 are pulled apart from each other while sandwiching the end part on the non-opening side of the zipper tape 1, which is the part opposite to the part held when testing the “opening strength by hands”.

In this test, since the bag is pulled while the end part on the non-opening side being held, the opening strength on the contents side is confirmed.

The opening strength on the contents side serves as a guide to confirm whether the leakage from the opening part 110 of the contents filled in the bag body 100. In this test, a larger maximum tensile strength leads to a higher opening strength on the contents sides, whereby the effects of preventing the leakage of the contents can be enhanced. Therefore, the maximum tensile strength of 50 or more is evaluated as “∘” and the maximum tensile strength of less than 50 is evaluated as “Δ”.

The zipper tape 1 of Examples 1 to 7 has a shape that satisfies any of the formulas 1, 2 and 5 that specify the difference between the distance A and the distance B (A−B), the angle C and the angle F.

In the above-tensile strength test which is conducted for Examples 1 to 7, in all of Examples 1 to 7, “⊚” or “∘”, showing the excellent evaluation results, were obtained.

In Examples 1 to 7, in particular in Examples 2 and 3, a high evaluation result “⊚” was obtained in the “opening strength by the sucker” . Therefore, a zipper tape having this dimension as a standard (main) can be one which fully satisfies the openability by an automatic machine and exhibits good openability by hands while ensuring opening strength on the contents side.

On the other hand, the zipper tapes of Comparative Examples 1 to 3 which, although satisfying the formula 5, not satisfying both of the formulas 1 and 2, exhibit poor evaluation results.

Specifically, the zipper tapes of Comparative Examples 1 to 3 showed the result of “Δ” in the “opening strength by a sucker”, in all of Comparative Examples 1 to 3.

This shows that openability by a machine is slightly inferior, and hence, the evaluation standards are not satisfied.

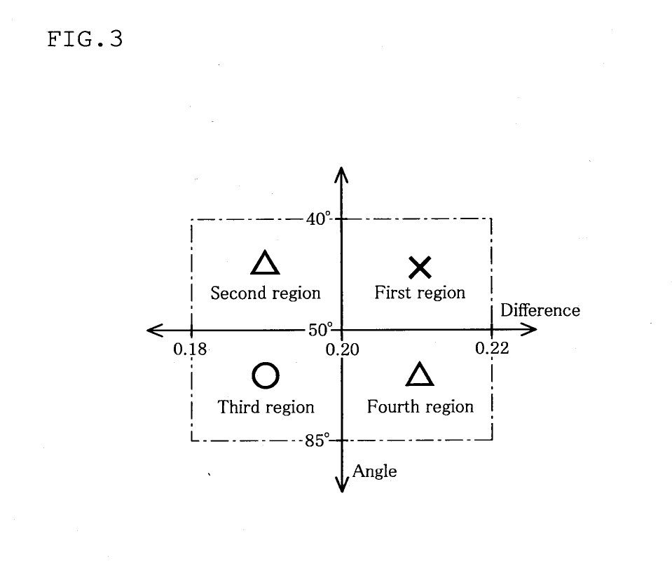

Here, the evaluation results of Examples 1 to 9, Comparative Examples 1 to 3 and other Comparative Examples are schematically shown in FIG. 3.

As shown in this figure, while the zipper tape 1 belonging to the third region including Examples 1 to 9 was evaluated as “∘”, the zipper tape belonging to the first region was evaluated as “x”. The zipper tape belonging to the second region was evaluated as “Δ”, and the zipper tape belonging to the fourth region was evaluated as “Δ”. That is, in the regions other than the first region, results satisfying the evaluation standards could not be obtained.

In the third region, even in the zipper tape 1 in which the difference (A−B) is less than 0.18 mm, the evaluation of “∘” was obtained.

From the above-mentioned evaluation results, the bag body 100 provided with the zipper tape 1 in which the difference (A−B) 0.20 mm and 50°≦C≦85° is one which improves both openability by hands and openability by an automatic machine while ensuring the opening strength on the contents side.

Further, it has been proven that, by specifying the angle F formed by the protruded part 12 on the opening side and the side surface 151 of the shaft part connecting therewith to be 100° to 140°, openability by hands is further improved, and good openability by an automatic machine can be ensured.

No specific restrictions are imposed on the material for the zipper tape 1. However, a polyolefin-based resin such as low-density polyethylene, linear low-density polyethylene and polypropylene or the like can be used. The zipper tape 1 can be produced from these materials by using a known profile extrusion or the like.

[Bag Body Provided with a Zipper Tape]

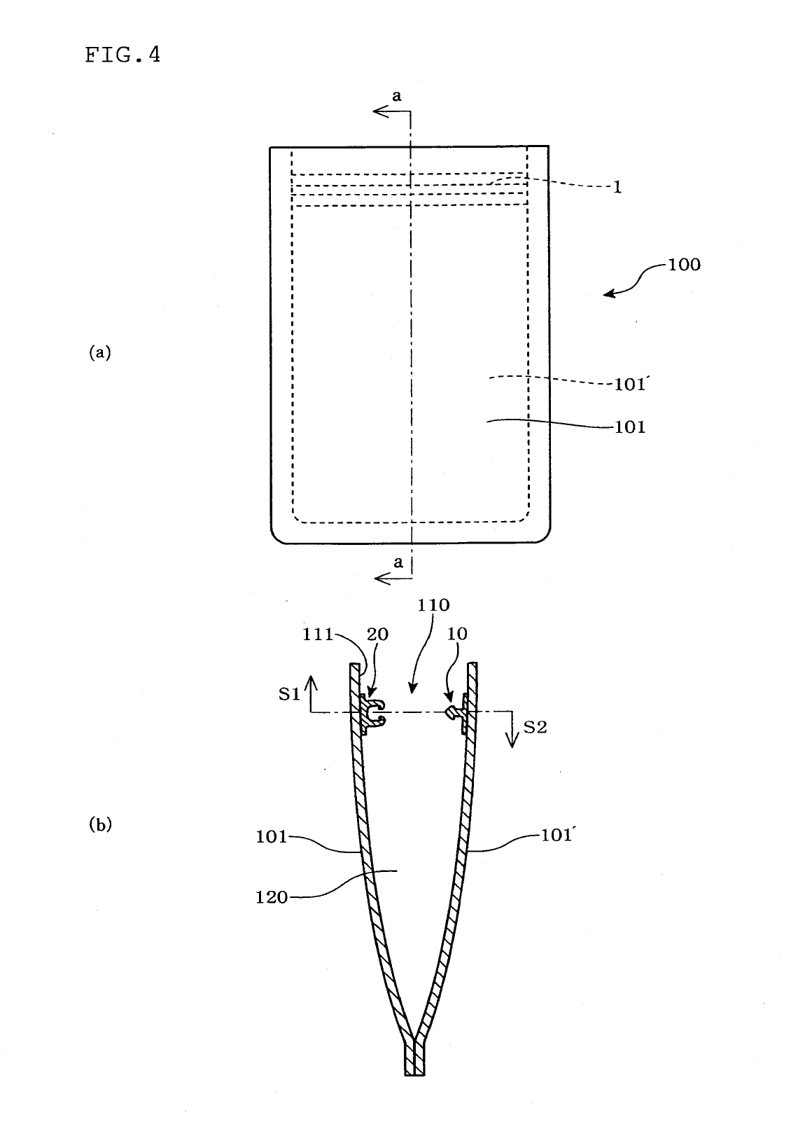

Next, the bag body 100 in which the zipper tape 1 according to the present invention is attached around the inner circumstance of the opening part 110 will be explained with reference to FIG. 4.

FIG. 4 is a schematic view showing the bag body 100 provided with the zipper tape according to this embodiment, in which (a) is a front view and (b) is a cross-sectional view taken along the line a-a of the bag in the opened state.

The bag body 100 provided with the zipper tape is formed in a flat pouch obtained by heat sealing the peripheries of a sheet 101 and 101′ formed of a polyolefin-based resin as in the case with the zipper tape 1.

In the bag body 100, the opening part 110 which opens in the upper part in the figure and an accommodating part 120 in which contents are filled are formed. The zipper tape 1 according to the present invention is fused to the inner surface of the opening part 110.

In the zipper tape 1, a male-side tape 10 and a female-side tape 11 are arranged such that they oppose to each other and such that the male part 16 and the female part 24 can be engaged.

At this time, the male-side tape 10 is arranged so that the protruded part 12 on the opening side is directed to the opening side S1.

By providing the zipper tape 1 in this way, the opening part 110 can be sealed in an openable and closable manner.

Further, the zipper tape 1 according to the present invention has a dimension and a shape, which are specified based on the above-mentioned evaluation standard.

Therefore, the bag body 100 provided with the zipper tape is configured to be one which has not only openability by hands but also good openability by an automatic machine while ensuring the opening strength on the contents side.

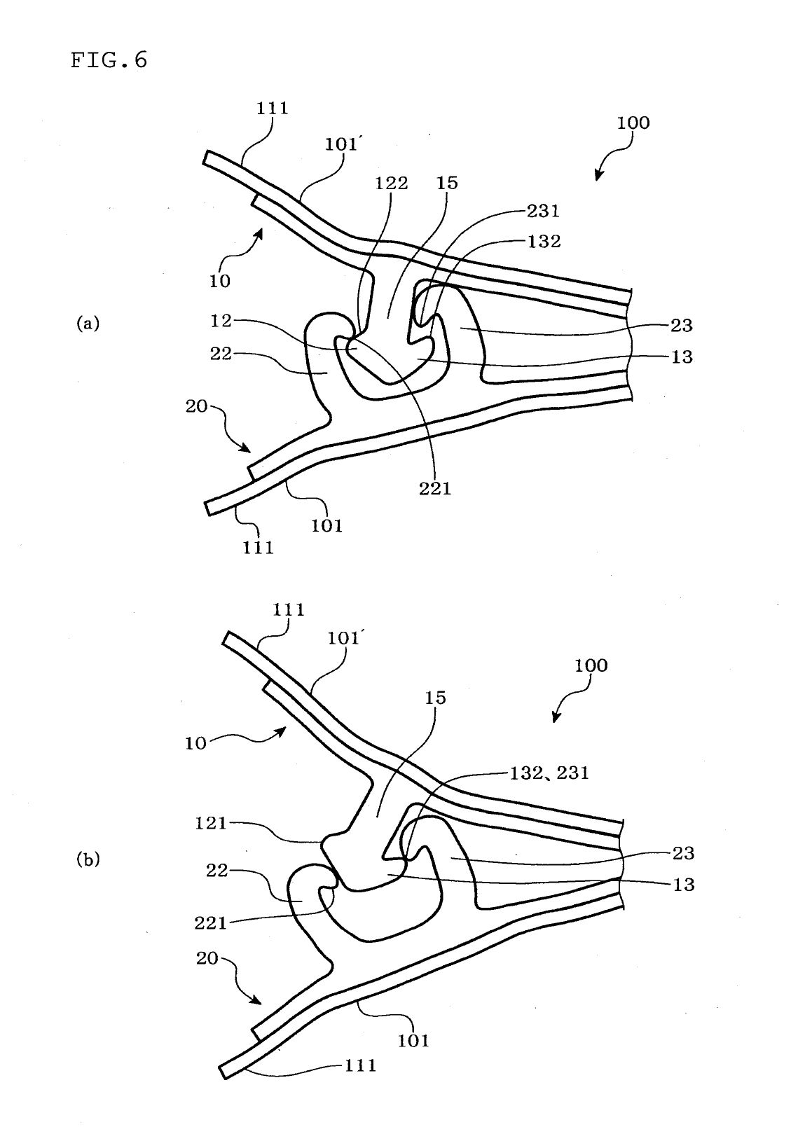

In order to evaluate the openability by an automatic machine, with reference to FIG. 6 which schematically shows the opening process of the bag body 100, the behavior of the occlusion part during the opening will be explained below.

As shown in FIG. 5(a), by arranging the sucker 200 in the vicinity of the zipper tape 1 of the bag body 100 which is in the engagement state and by vacuum sucking the bag body 100, a sucking force acts such that the male part 16 and the female part 24 are gradually separated from the end part 111 due to the arrangement of the sucker 200 shown in this figure.

As a result, as shown in FIG. 6(a), at first, the protruded part 12 on the opening side abuts the female part 22 on the opening side. Precisely, the inclined surface 122 of the shaft part of the protruded part 12 on the opening side abuts a front part 221 of the female part 22 on the opening side.

At this time, the inclined surface 122 of the shaft part acts such that it pushed down the female part 22 on the opening side outwardly.

With a further increase in suction force, the shaft part 15 receives a drag force given by the front part 221 of the female part 22 on the opening side, and is elastically deformed in a circular shape which swells toward the opening side S1.

That is, the root of the shaft part 15 (side surface 151 of the shaft part) acts as a pivot point, and the inclined surface 122 of the shaft part which abuts the front part 221 of the female part 22 of the opening side acts as a working point, whereby the shaft part 15 is elastically deformed.

At this time, due to the relationship of the difference A−B≦0.2 mm (in an extreme case where the distance B is longer than the distance A, for example), as shown in FIG. 6(a), the degree of engagement of the protruded part 13 on the non-opening side with the female part 23 on the non-opening side becomes small (for example, the front part 231 on the female part 23 on the non-opening side and the protruded part 13 on the non-opening side are separated), and hence, it is hardly affected by the female part 23 on the non-opening side, and can be withdrawn easily.

As a result, the drag force given by the front part 221 of the female part 22 on the opening side is concentrated on the protruded part 12 on the opening side.

As a result, with an increase in suction force, the front part 221 of the female part 22 on the opening side gradually slides down from the inclined surface 122 of the shaft part, and finally, as shown in FIG. 6(b), the protruded part 12 on the opening side is withdrawn from the female part 22 on the opening side.

At this time, effects exerted on the withdrawal by the angle F formed by the protruded part 12 on the opening side and the side surface 151 of the shaft part connecting therewith are not small, and withdrawal becomes easy as the angle F becomes acute.

Then, due to the withdrawal of the protruded part 12 on the opening side from the female part 22 on the opening side, the shaft part 15 is restored from the elastically-deformed state. Therefore, the head part 14 is rotated in a clockwise direction in the figure. This rotation acts such that the protruded part 13 on the non-opening side is withdrawn from the female part 23 on the non-opening side.

At this time, since the angle C is 50°≦C≦85°, the following behavior is shown.

After the protruded part 12 on the opening side is withdrawn from the female part 22 on the opening side, the suction force is concentrated on the female part 23 on the non-opening side. At this time, the protruded part 13 on the non-opening side gradually inclines (in the figure, downward inclination to the right) while it slidably contacts the front part 231 of the female part 23 of the non-opening side. Thereafter, the front part 231 on the female part 23 on the non-opening side slides down from the protruded part 13 on the non-opening side. As a result, engagement of the protruded part 13 on the non-opening side and the female part 23 on the non-opening side are released.

From such behavior, by allowing the angle C which is formed by the protruded part 13 on the non-opening side and the side surface 152 of the shaft part to be an obtuse angle, while the drag force which the protruded part 13 on the non-opening side receives from the front part 231 on the female part 23 on the non-opening side is reduced. On the other hand, by allowing the angle C to be acute, the durability of the drag force can be enhanced.

That is, by allowing the angle C to be further obtuse, while openability can be further improved, the opening strength on the contents side is reduced.

Therefore, according to the present invention, as shown in the formula 2, based on the evaluation test as mentioned above, the angle C is specified as a value which is aimed at attaining both the opening strength on the contents side and the openability by a machine.

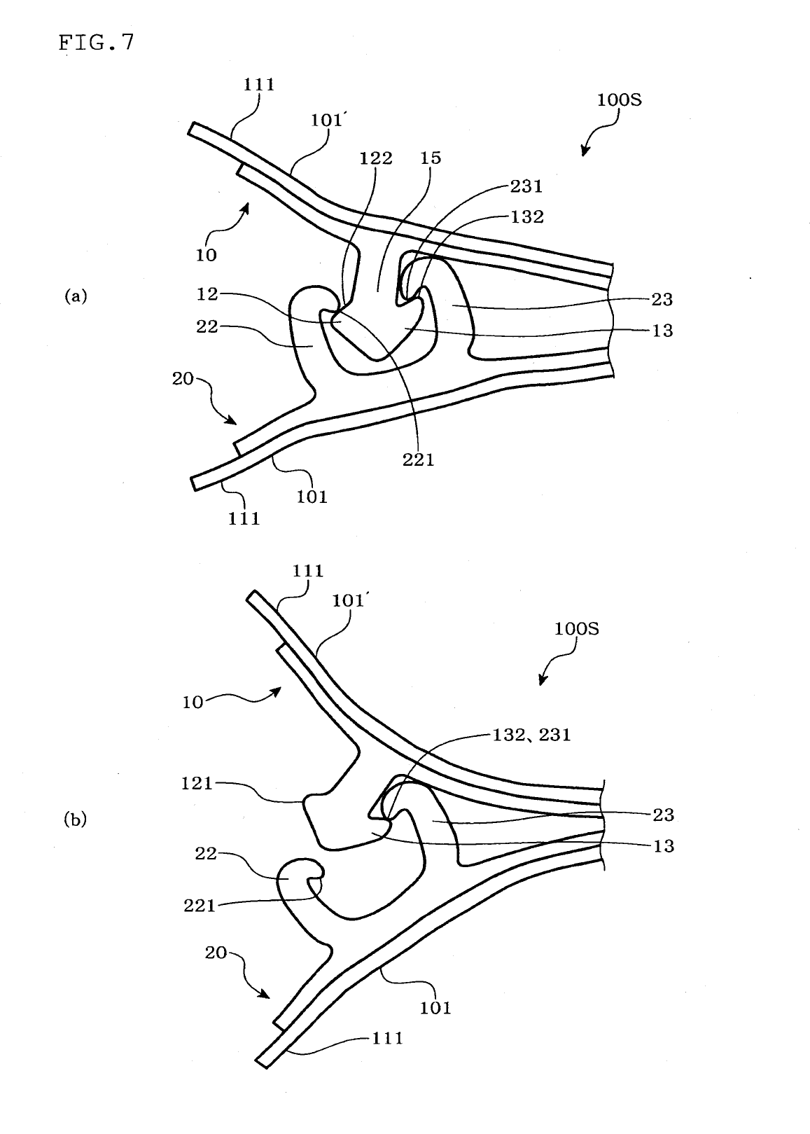

On the other hand, in the comparative example of a bag body 100S provided with a zipper tape which does not satisfy the relation of the formula 1 but satisfies the relationship A−B>0.20 mm, the behavior of the occlusion part when the bag is opened by an automatic machine will be explained with reference to FIG. 7.

As compared with the bag body 100 of this embodiment, in the bag body 100S according to the Comparative Example, for example, the distance B is shorter than the distance A so as to satisfy the relationship the difference A−B>0.20 mm. As a result, as shown in FIG. 7(a), the protruded part 13 on the non-opening side becomes more strongly engaged with the female part 23 on the non-opening side, and the bag body is affected in no small way by the female part 23 on the non-opening side, whereby the elastic deformation of the shaft part 15 is inhibited, and hence, withdrawal hardly occurs.

As shown in FIG. 7(b), after the protruded part 12 on the opening side is withdrawn from the female part 22 on the opening side, the protruded part 13 on the non-opening side tends to be inclined gradually, while slidably contacting the front part 231 of the female part 23 on the non-opening side (in the figure, downward inclination to the right). However, as a result of reduction of the distance B, the top part 232 of the female part 23 on the non-opening side is caught in the protruded part 13 on the non-opening side, whereby an increase in the inclination is inhibited. As a result, withdrawal of the protruded part 13 on the non-opening side becomes difficult.

As mentioned above, it can be understood that the openability is decreased by allowing the difference A−B>0.20 mm.

As explained hereinabove, according to the zipper tape 1 of this embodiment and the bag body 100 in which the zipper tape 1 is attached to the opening part 110, by specifying the optimum dimension and shape of the occlusion part at which the occlusion and engagement are conducted, the openability by hands and the openability by an automatic machine can be both improved while ensuring the opening strength on the contents side. As a result, insufficient opening is eliminated, whereby the production efficiency can be increased.

### Other Embodiments

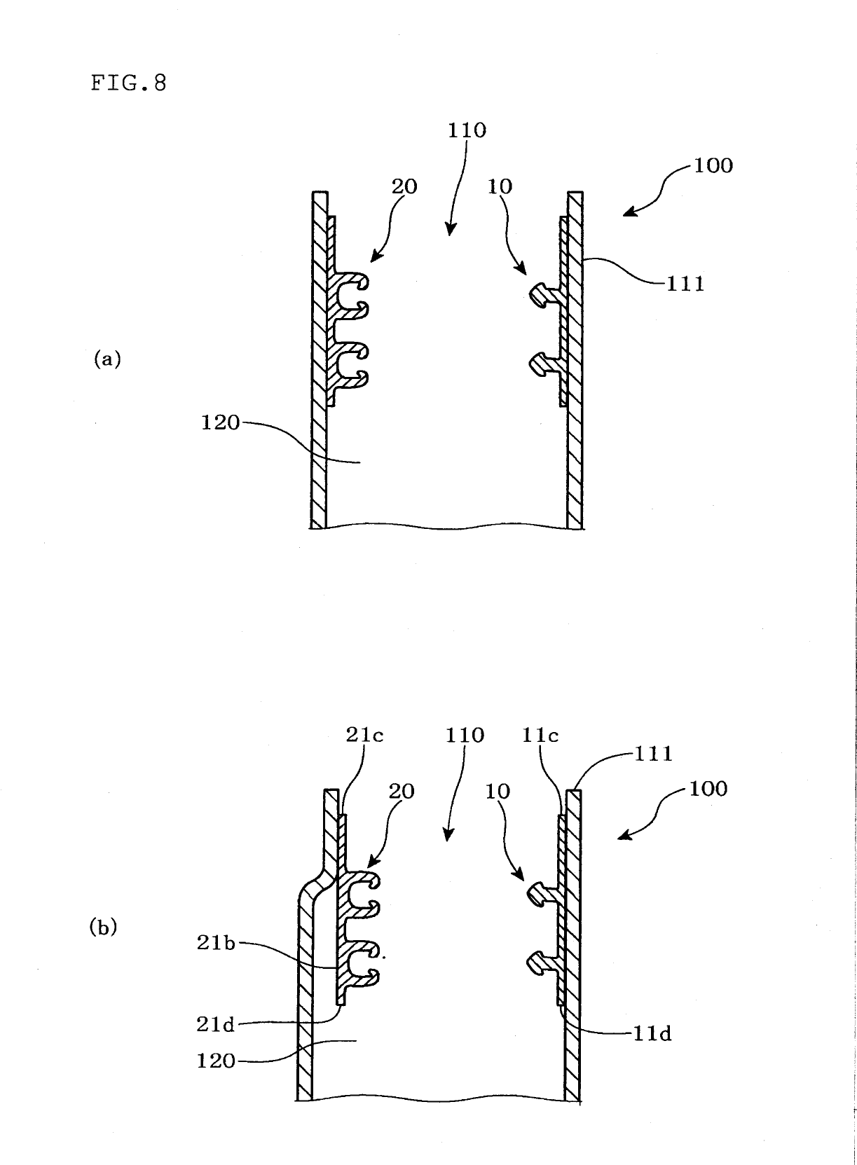

Next, as for other embodiments of the bag body 100 provided with a zipper tape according to the present invention, an explanation will be made with reference to FIG. 8 which shows the cross section thereof.

The bag body 100 provided with a zipper tape shown in FIG. 8(a) has a plurality of pairs of a male part and a female part which can be engaged with each other, and is characterized in that at least one pair of a male part and a female part are formed of the male part 16 and the female part 24 of the zipper tape 1 according to the present invention.

Specifically, this bag body 100 is a double zipper-type bag body having two pairs of occlusion parts. In the stripe-shaped bases 11 and 21 of the male-side tape 10 and the female-side tape 20, two male parts which are respectively located on the opening side and the contents side and two female parts which are respectively located on the opening side and the contents side are formed in a protruded manner, and a pair of a male part and a female part located on the opening side and a pair of a male part and a female part located on the contents side are arranged such that they oppose to each other and can be engaged with each other.

Of these, at least one pair of the male part and the female part are configured as the male part 16 and the female part 24 that satisfy the relationships shown in the formulas 1 and 2.

Due to such a configuration, as compared with a case in which a pair of occlusion part is formed, the opening strength on the contents side can be further enhanced.

In the bag body 100 provided with a zipper tape shown in FIG. 8(a), all of the two pairs of the male part and the female part are the male part 16 and the female part 24 satisfying the relationship shown by formulas 1 and 2. However, it is possible to form at least one pair of the male part and the female part can be formed as a sealed type occlusion part where the male part and the female part are in surface contact. The occlusion part may be formed in a quantity of three pairs or more, not limiting to two pairs.

In the above-mentioned double-zipper type bag body 100, the following configuration can be added. The bag body 100 provided with a zipper tape shown in FIG. 8(b) is characterized in that the end part on the content sides of one of the stripe-shaped bases is not fused to the bag body 100.

Specifically, in this bag body 100 provided with a zipper tape, at least one of the stripe-shaped bases of the male-side tape 10 or the female-side tape 20, at least the end parts 11c and 21c on the opening side and the end parts 11d and 21 d on the contents side are respectively fused to the bag body 100. As for the other stripe-shaped bases 11 and 21, only the end parts 11c and 21c on the opening side are fused to the bag body 100, and the end part 11d and 21d are not fused to the bag body 100.

Due to such a configuration, the following action and effects are exhibited.

By applying an external pressure to the bag body filled with contents, the internal pressure in the accommodating part 120 is increased. At this time, in the above-mentioned embodiment in which all of end parts 11c, 11d, 21c and 21d of each stripe-shaped base are fused to the bag body 100, this internal pressure acts as a force which releases the occlusion and engagement, i.e. a force that pulls the male part 16 and the female part 24 apart almost equally.

However, since one of the end parts 11d and 21d on the content side is not fused to the bag body 100, this internal pressure does not act entirely as a force for pulling the male part 16 and the female part 24 apart. Part of this internal pressure acts as a shear force that peels the stripe-shaped bases 11 and 21 on the non-fused side off from the bag body 100, whereby the internal force can be dissipated.

That is, since the end parts 11d and 21d on the contents side are not fused to the bag body 100, the internal pressure, which should originally be concentrated on the releasing of the occlusion and engagement, is dissipated, whereby the opening strength on the contents side can be improved.

In particular, in an example shown in FIG. 8(b), in the stripe-shaped base 11 of the male-side tape 10, at least the end part 11c on the opening side and the end part 11d on the contents side are respectively fused to the bag body 100. As for the stripe-shaped base 21 of the female-side tape 21, only the end part 21c on the opening side is fused to the bag body 100, and in the end part 21 d on the contents side, the back side 21b thereof is not fused to the bag body 100.

Due to such a configuration, experimental results are obtained that, as compared with a case where the end part 11d on the contents side in the male-side tape 10 is not fused, the opening strength on the contents side is increased.

Although the above-mentioned configuration is applied to a double-zipper type bag body, it can also be applied to a single-zipper type bag body as shown in FIG. 4(b).

As explained hereinabove, according to other embodiments of the bag body 100 provided with a zipper tape of the present invention, the opening strength on the contents side can be further enhanced.

Hereinabove, an explanation is made on the present invention with reference to a plurality of embodiments. It is needless to say that the present invention is not restricted only to the above-mentioned embodiment, and various modifications can be made within the scope of the claims.

For example, in the bag body 100 provided with a zipper tape of the above-mentioned various embodiments, the bag body is formed as a flat pouch. However, a bag body in the form of a standing pouch can also be used.

Further, regarding other items to be specified including the distance D between the side surface 152 of the shaft part and the top part 131 of the protruded part 13 on the non-opening side, the distance E between the side surface 151 of the shaft part and the top part 121 of the protruded part 12 on the opening side and the angel F formed by the protruded part 12 on the opening side and the side surface 151 of the shaft part connecting therewith, it is possible to seek further preferable dimensions by conducting additional examples.

In the above embodiment, the female part 24 (22 and 23) is formed in a line symmetrical manner, but it may be formed asymmetrically.

Specifically, the angle formed by the wall surface of the outside of each female part 22 and 23 and the angle formed by the surface 21a of the stripe-shaped base 21 is almost a right angle. However, for example, the angle in the female part 23 (the female part on the non-opening side) can be formed as an acute angle (see FIG. 1 on page 6 of the JP-A-H09-28421).

### INDUSTRIAL APPLICABILITY

The present invention can be widely applied to a bag body provided with an openable and re-openable zipper tape.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification are incorporated herein by reference in its entirety.

### Explanation of Symbols

1. Zipper tape

11, 21 Stripe-shaped base

16. Male part

14. Head part

15. Shaft part

12. Protruded part on the opening side

121. Top part

13. Protruded part on the non-opening side

132. Front part

24. Female part

22. Female part on the opening side

221. Front part

23. Female part on the non-opening side

231. Front part

100. Bag body provided with a zipper tape

110. Opening part

120. Accommodating part (contents)

1. A zipper tape comprising a strip-shaped base provided along the inner circumference of an opening of a bag body for accommodating a prescribed contents; and a male part and a female part which are provided in the strip-shaped base in a protruded manner and can be engaged with each other,
the male part comprises:
a head part that forms a protruded part on the opening side which protrudes from the opening to the outside of the bag body and a protruded part on the non-opening side which protrudes from the opening to the contents side; and a shaft part which connects the head part and the strip-shaped base;
the female part comprises:
a female part on the opening side and a female part on the non-opening side, each female part having an end part in the form of a hook such that it opposes to the strip-shaped base,
the female part on the opening side is engaged with the protruded part on the opening side and the female part on the non-opening side is engaged with the protruded part on the non-opening side;
wherein in an engagement state in which one of the male part and the female part abuts the stripe-shaped base of the other,
the distance A between the front end part of the female part on the opening side and the top part of the protruded part on the opening side, the distance B between the front end part of the female part on the non-opening side and the front part opposing to the stripe-shaped base in the protruded part on the non-opening side, and the angle C formed by the protruded part on the non-opening side and the side surface of the shaft part connecting therewith satisfies the relationship represented by the following formulas:
A−B≦0.20 mm
50°≦C≦85°

2. The zipper tape according to claim 1, wherein the angle F formed by the protruded part on the opening side and the side surface of the shaft part connecting therewith satisfies the relationship represented by the following formula:
F=100°≦140°

3. The zipper tape according to claim 1, wherein it is provided with a plurality of pairs of a male part and a female part which are formed on the strip-shaped base in a protruded manner and can be engaged with each other;
at least one pair of a male part and a female part of the plurality of pairs of a male part and a female part is the male part and the female part according to claim 1;
of the strip-shaped bases on which the male part or the female part is formed in a protruded manner, one of the strip-shaped bases has a configuration in which at least the end part on the opening side and the end part on the contents side are respectively fused to the bag body, and
the other of the strip-shaped bases has a configuration in which only the end part on the opening side is fused to the bag body and the end part on the contents side is not fused to the bag body.

4. A bag body for accommodating a prescribed content, wherein it is provided with the zipper tape according to claim 1.
